(19) United States
(12) Patent Application Publication
(10) Pub. No.: US 2021/0331220 A1
(43) Pub. Date: Oct. 28, 2021

(54) SPIKED SURFACES AND COATINGS FOR DUST SHEDDING, ANTI-MICROBIAL AND ENHANCED HEAT TRANSFER PROPERTIES

(71) Applicant: MHI Health Devices, LLC., Cincinnati, OH (US)

(72) Inventor: Jainagesh Sekhar, CIncinnati, OH (US)

(73) Assignee: MHI Health Devices, LLC., Cincinnati, OH (US)

(21) Appl. No.: 17/231,115

(22) Filed: Apr. 15, 2021

Related U.S. Application Data
(60) Provisional application No. 63/016,769, filed on Apr. 28, 2020.

(51) Int. Cl. B08B 17/06; C22C 38/28; C22C 38/06

(52) U.S. Cl. CPC B08B 17/06; C22C 38/06; C22C 38/28

(57) ABSTRACT

Presented is a structure having super-hydrophobic characteristics comprising a substrate having a hierarchical nano-surface featuring asperities that are tunable and may be arranged or engineered for specific wear, antimicrobial or dust repellant aspects wherein the asperities may be pillared or spiked shaped. Included also are possible methods of production for such structures including generation through the application of area electro-shear-vibratory-thermal plasma.

### CROSS REFERENCE TO RELATED APPLICATIONS

This patent application claims the benefit of provisional patent application Ser. No. 63/016,769, filed on Apr. 28, 2020, entitled “Tunable Hydrophobic Surfaces For High Performance Material Applications and Methods to Produce Same” by the present applicant, the disclosures of which are incorporated by reference herein in their entireties. Related to the present application is U.S. Pat. No. 10,850,441 entitled “SURFACES HAVING TUNABLE ASPERITIES AND METHOD”, also by the present applicant, which is incorporated by reference its entirety.

### BACKGROUND

There exists a growing need for super-hydrophobic surfaces that remain clean, sanitary (anti-microbial) and dust free which are required for various high-tech applications including space exploration (e.g., NASA initiative to return to the moon). Concurrent with the need for such surfaces are new and effective methods and processes to produce such surfaces. To meet the above need, these methods may generate adequate nano-structured hierarchical surfaces for low energy-use dust removal.

With the rapid development of nanotechnology in materials science, super-hydrophobic surfaces are now commonly used, yet the applications are cost limited. However, two successful commercial products appear to be water repellant textiles embedded with oxide nanoparticles and reflective coated mirrors used in automobiles. Hydrophobicity requires both high surface energy and engineered fibril texture to create conditions of low wettability and slide off.

A review of the literature indicates that substantial progress has been made to date with idealized bio-mimetic super-hydrophobic materials with simulated demonstrations on organic or silicon containing substrates or similar materials. NASA scientists have made substantial progress with primer-based coatings containing silicon. Super-hydrophobic surfaces with intelligent self-healing functions have been developed to overcome durability challenges and prolong the lifespan of the super-hydrophobic surface behavior. However, these coatings are mostly for soft matter and silica-glass. Many of the hydrophobic coatings that are in use in products such as shoes and cell phones are based on a chemical coating, inspired by living organisms, releasing low-surface-energy agents.

Such compositions, as above, and reforming topographic structures are the two main techniques to fabricate self-healing super-hydrophobic surfaces. Compositing with hydrophilic regions i.e., alternating regions of micron-size zones for the attraction of water and, the repelling of it, has also been suggested. Such a composite surface could be used to collect fresh water from the air as well for surface cleaning. Although information is available that suggests that hydrophobic surfaces may hold the key to the dusting problem, there are several unknowns when it comes to real surfaces and mass production methods for manufacture, particularly for hard surfaces.

### Conditions for Thermal Body Forces for Roll-Off and Dust Removal

Several methods have been proposed for dust removal from surfaces. These include mechanical brushing, air jet blowing, electrostatic repelling, water film washing and splashing, and water droplet cleaning. Some of these surface cleaning methods are involved with energy intensive processes and require external cleaning resources such as compressed air and clean water. Self-cleaning surfaces provides several advantages over the conventional water film/jet or compressed air jet cleaning methods because of low energy and minimum resource requirements.

Surface roughness is shown to have a profound effect on both the wetting and spreading process as well as droplet-sweep dust collection and roll-off. Even solar panels today have rough surfaces for high efficiency cleaning.

FIG. 1 shows two types of wetting states that are recognized for droplet interactions with nanostructure pillared surfaces. These are the Wenzel (W) and Cassie-Baxter (C-B) states. In the case of the C-B state, pockets of air or vacuum are trapped during liquid wetting, thus forming a liquid-solid-air composite interface. The C-B state gives rise to super-hydrophobicity by texture manipulation.

FIG. 2 displays the C-B interface that is characterized by a large contact angle along with a small sliding-angle (i.e. a droplet rolls off rather than sliding off). The surface texture/roughness, the use of low surface energy materials, and re-entrant geometry (same as grooving discussed in the tasks) are key design parameters for both super-hydrophobicity (requires hierarchical micro-nanostructure) and super-oleo-phobic (which requires re-entrant tips in addition-see). Since the fully wetted Wenzel state is usually more stable than the C-B state, considerable attention has been paid to models and ideas for stabilizing the C-B state by altering the energy barriers and roughness (defined as the ratio of real to the projected area). Hierarchical roughness structure and re-entrant angle at the liquid-solid-air interface are shown to be key enablers, not only to stabilize the C-B composite state from transitioning to the more stable W state, but also to increase its resistance to collapse when an external pressure is applied. For a lower roughness (e.g., with a larger pitch between the asperities) the W state is more energetically profitable, whereas for a higher roughness the C-B regime is more energetically profitable. With decreasing roughness, the system is expected to transit to the W state. However, a special type of C-B composite state can also be formed on hierarchical grooved surfaces, which are known to lead to rapid directional wetting and roll-off with high stability of the C-B texture.

### Known Design for Super-Hydrophobicity and Dust Removal

The guidance from the literature can be summarized into the following main points: (1) Very low energy surfaces, including those comprised of oxynitrides, promote hydrophobic behavior. Surface energy for metals typically are 1000 mJ/m² while glass is about 80 mJ/m², plastics around 50 mJ/m² and oxynitrides at roughly 25-40 mJ/m². Oxynitride surfaces are also tunable (surface features may be designed or adjusted). (2) For a stable C-B state the solid area fraction should not exceed 0.2. An instability leads to a Wenzel state. (3) Lower hysteresis leads to better roll-off (4) There is a thermal gradient across the surface and droplet that can cause rolling of droplets. (5) Super-hydrophobic texture conditions offer the lowest energy requirement for droplet detachment and roll-off.

In order to design the best hydrophobic surface with a new process, the known design heuristics are important to follow with guidance also from biomimetic structures. It should be noted that there is only limited guidance on stability from known mathematical models. When the spacing is less than the width of a single pillar, Cassie's law (that gives the C-B texture) is a poor predictor of the contact angle. The C-B state could switch to the Wenzel state, resulting in a sudden breakdown of super-hydrophobicity. At low roughness i.e., when asperities on a surface are widely spaced (solid area fraction is between 0 and 0.20), there is a good agreement between Cassie's law that describes the C-B state. There is an ongoing discussion regarding the legitimacy of using equilibrium contact angle as the sole criteria for identifying the phenomena of cleaning. Some studies have argued that the “stickiness” (hysteresis) of a surface should be considered also in characterizing super-hydrophobicity. C-B droplets tend to have a low hysteresis compared with W droplets. In the C-B condition the droplet adherence is low, so the droplets can be shaken-off.

A droplet in motion experiences rolling/sliding on the hydrophobic surfaces. The droplet size, acceleration, and wetting state of the surface play a major role on the droplet dynamics. The hydrophobic surface with low contact angle promotes low hysteresis droplet rolling rather than sliding. Smaller size droplets roll like marbles and do not suffer from wobbling on the surface unlike large size droplets. Depending on the contact angle hysteresis, the retaining force effects the droplet rolling. The droplet undergoes mixed motion consisting of sliding and rolling on the surface for large values of contact angle hysteresis.

### SUMMARY

The structure and method of this application focus on the creation of super-hydrophobic and dust repellant texture for metals and non-metals from that may be normally somewhat hydrophilic. The surface texture methods proposed herein are for making their surfaces super-hydrophobic. The proposed process utilizes the newly available powerful wide-area plasma-beam device described in detail further below. The ensuing surfaces exhibit nano-pillar asperities with compositionally tunable hard oxynitrides that have an extremely low surface energy. The rapid surface grown oxynitride and hydroxy-nitride nanostructured-materials are to date are hydrophobic but not enough for an adequate roll-off of a water cleaning droplet. Oxynitrides offer low surface energy of around 50 mJ/m² compared to the base metals (aluminum, steel, glass) which are closer to 1000 mJ/m².

As stated, this application discusses a new method to make the surface super-hydrophobic with the powerful electro-shear-vibratory-thermal plasma (E-Ion Plasma) treatment. This is expected to enable hierarchical surface structures at an extremely low projected cost of surface processing. The disclosed process will greatly assist in meeting the challenges for low dust and antimicrobial surfaces, an expectation based on the preliminary results generated to date on wettability, self-cleaning and antimicrobial testing.

The E-Ion Plasma is a wide-area electro-shear-vibratory-thermal plasma which is expected to primarily enhance vibrational excitations in a flowing gas with phonon-boson interactions that produce a stable plasma beam. This type of plasma has the advantage of scalability and of allowing rapid processing of sundry part-introduction and change-out, a must for volume production. The main benefits of the E-Ion Plasma are wide-area stable plasma even for the very difficult open-plume configuration. This plasma has no combustion requirements (thus highly environment positive) and offers a clear reduced cost of processing in all configurations (i.e. for both the inline and open discharge configuration).

The ionic or highly energized radical character of the E-Ion beam places it at 10²¹ activated species per cubic meter. Additionally, the beam power density, assuming just equivalent of 0.1-1% ionization, is 10⁶-10⁹ W/m² which is higher than most high-power lasers. A laser beam generally offers only a few mm wide beam. The E-Ion open plasma beams are about 200 mm long with diameters ranging from a few mm to over 400 mm with multiple plasma filaments if required for very wide beams. There is no combustion, microwave or RF that is required—these prevent scalability. The plasma is produced at about 1 m³ flow of gas per 10-15 KW unit. The plasma exit velocity is about 1-10 m/s, or in other words, the volume is 0.02 to 0.2 m³ is produced per second for a 10 KW system. For air, one mole is 0.0224 m³. Thus, about ˜10²⁰-10²² ions are available per cubic meter.

### DRAWINGS—FIGURES

FIG. 1 depicts interaction of a water droplet placed upon a surface that is a condition exhibiting the Cassie state and the Wenzel state of wettability.

FIG. 2 represents a comparison of hydrophobic and hydrophilic surfaces and their expected respective contact angles and characteristics.

FIG. 3 is a photograph of a nano-pillared surface generated through the application of area electro-shear-vibratory-thermal plasma.

FIG. 4 is a photograph of a grooved nano-pillared surface generated through the application of area electro-shear-vibratory-thermal plasma.

FIG. 5 is a photograph of a grooved nano-spiked surface generated through the application of area electro-shear-vibratory-thermal plasma suitable for the low energy shedding of dust and other particles.

FIG. 6 is a photograph of nano-pillared hierarchical structure generated through the application of area electro-shear-vibratory-thermal plasma.

FIG. 7 is an idealized hierarchical structure showing asperities generated on the surfaces of other asperities.

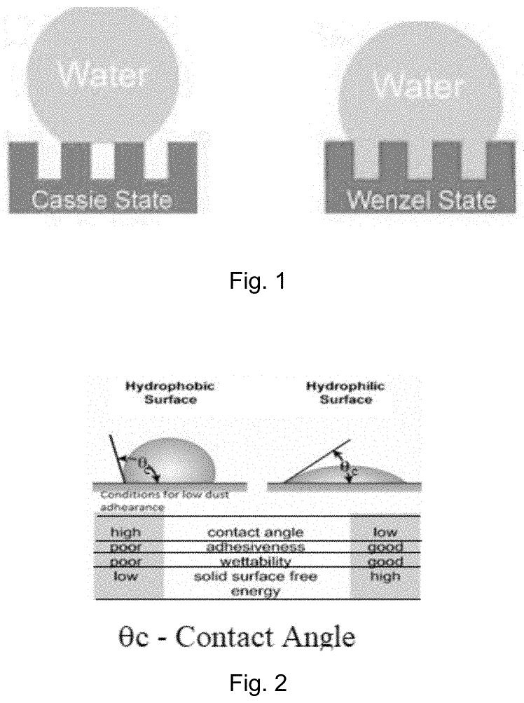

### DESCRIPTION

An overall objective of this new technology is to present the best cleaning framework (lowest energy requirements) that is expected for super-hydrophobic surfaces of hard materials. All metals and glasses can be augmented with easy cleaning properties. Experiments have been performed on three representative materials namely an aluminum 6061 alloys, bearing steel alloy 52100 and alkali alumino-silicate glass. The nominal composition of type 6061 aluminum is 97.9% Al, 0.6% Si, 1.0% Mg, 0.2% Cr, and 0.28% Cu. Although it is an age-hardenable alloy the exposure time to the E-Ion Plasma has negligible thermal influence on the bulk of the material below the surface, because the exposure time is typically in seconds. Bearing steel alloy 52100 has a nominal composition of 1.05% C, 0.35% Mn, 0.30% Si, 1.50% Cr and the remainder Fe. Alkali alumino-silicate glass is of the type commonly used as cell phone cover glass.

The E-ion Plasma requires nitrogen and steam generators. Such thermal plasma generation and applications are discussed in U.S. Pat. No. 9,643,877, “Plasma Treatment Method” and U.S. Pat. No. 8,895,888, “Anti-smudging, better gripping, better shelf-life of products and surfaces” the disclosures of each being incorporated by reference in their entireties. The plasma employed is of a thermal nature at high temperatures that is comprised partially of activated species of ions. The thermal plume also contains bosons and photons. Air or other gasses may be used to generate the plasma plume and other materials may be introduced into the plasma flow to impart properties of those materials to the flow and project the properties to a structure within the plume.

The application of the E-Ion thermal plasma to these materials results in reproducible low-cost durable hard-material surfaces that display tunable hydrophobic to super-hydrophobic behavior from their nanostructure textures. The process-time target for a surface will be within one minute for a 1.0 m² (˜10 ft²) surface (from untreated to fully treated) in order to make the process scalable and cost-competitive. This is at least two orders of magnitude or better than any other process that is in use today. For the first time an industrially feasible method for real surfaces is presented.

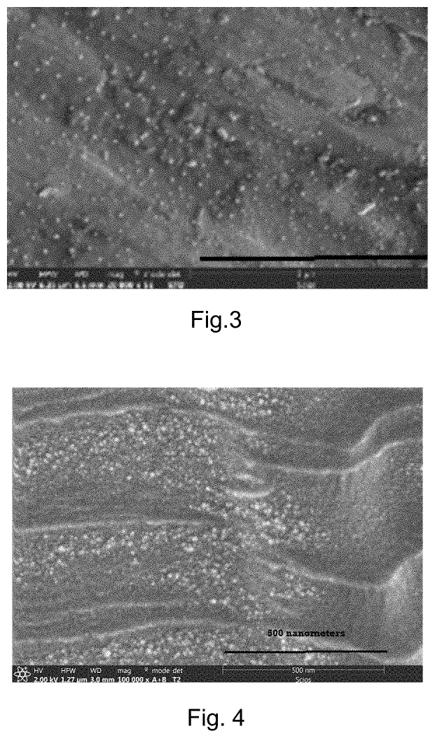

FIG. 3 is a micro-photograph of a surface generated by thermal plasma populated with pillar-like asperities. The surfaces produced by the application of thermal plasma provides easy-to-clean features (quantified by energy measurements) that are dust repellant, super hydrophobic and are durable against abrasion. The surfaces, as shown in FIG. 3, may have oxynitride fibril-asperities (nanopillars) that are hard, have high elastic moduli and are chemically tunable for surface energy. Any abrasion will only create more positive re-entrant channels (grooves) that are super-hydrophobic. The surfaces may be comprised of hard-material objects that can be constructed of nano-sized pillars (asperities), poles and other structures that show super-hydrophobic behavior. Asperities in dendritic morphologies are also contemplated by the applicants.

FIG. 4 is a photograph of a surface exhibiting an easy to clean super-hydrophobic surface may be produced with a nano-hierarchal structure with grooves. This will allow a three-degree roll-off angle for dust or liquid. This is a condition allowing for easy rotation and dislodging of a droplet. Droplets will roll off along the grooves. The addition of asperities on top of the groove surfaces enhance this condition.

Water droplets pick up dust particles from a surface during rolling/sliding on the hydrophobic surface. However, the rate of the dust particles removal depends on the droplet size and the dust particles' cloaking efficacy by the droplet liquid. Where good roll-off is noted the particles are easily removed from the inclined surface by a water droplet that rolls with a low qr. With the presence of dust particles (1-50-micron size) on a hydrophobic surface that has nanometer scale roughness, the millimeter size droplet could experience an increase in the friction forces.

The droplet motion is often governed by both sliding and rolling. The velocity for dust particles' cloaking must provide residence time of the millimeter size droplet on the surface during sweeping. If the droplet rolls off too fast, dust could be missed as the droplet acceleration influences the rate of picking the dust particles by the droplet. The inclination of the surface increases the gravitational force component on the droplet mass and the droplet acceleration along the inclination. The texture morphology of the surface plays important role on the droplet dynamics. The transition time of the droplet wetting on the hydrophobic surface is larger than the droplet fluid cloaking time of the dust particles.

### DETAILED DESCRIPTION

This application presents a process to produce desired super-hydrophobic surfaces on metals and glass with in-situ grown oxynitride and hydroxy-nitrides even with carbon, silicon, phosphorous contents to the macro and nano-structured asperities. The base materials upon which the surfaces are applied in this application are those that are employed in the United States Space Program wherein the surfaces do not contain organic paints/primers or silica binders and have enhanced high temperature and high modulus performance. It is also noted that grooves and similar surface features appear to dramatically reduce the energy for roll off. Droplets are shown to move faster in the direction parallel to the grooves through wetting of the solid strips. In the orthogonal direction to the grooves, the contact line advances by hopping from one solid strip to another and is slower as this increases the chance of pinning and thus results in both large a contact angle and sliding (roll-off) angle. With appropriate surface texturing, such surfaces with interesting unidirectional, bidirectional, and other spreading ability are thought possible for metals and glass as discussed below. The nanostructure is also expected to make the surface antimicrobial (antibacterial, anti-virus, anti-fungal).

The fabrication technique for super-hydrophobic surfaces must be able to create tunability in various ways, including if required a hydrophobic and hydrophilic composite surface. In a preferred embodiment for metallic alloys a two-step process will be used. First, a depositor will be used to deposit micron size rough surface with grooves, then the E-Ion Plasma will be applied to create the nano-asperity growth (such as pillars or spikes). Masking the surface before the deposition process with loose wires or other masks will be the method to create the grooves. For glass only, the E-Ion plasma single step exposure is contemplated. The duration for the E-Ion exposure will range from 15 second to 30 seconds (typically over 5 square cm²).

Alloy 6061 coupons were treated for 15-30 second in the nitrogen steam-plume (E-Ion). The initial polish was 0.5 micron. The surface was cooled in air with no quenching. This is an aluminum alloy used for structural and electronic parts. Normally alloy 6061 surfaces are hydrophilic to mildly hydrophobic when oxidized.

The bearing alloy 52000 (about 5 cm² flat and 6 mm ball bearings) was treated for 15-30 second in the nitrogen-steam plume. The initial polish was to 0.5 micron. This the most common bearing alloy. Normal surfaces are hydrophilic and oleo-phylic. No quench was be employed and the structure was cooled in air

Alkaline alumino-silicate flat-glass was treated for 1-3 minutes in a nitrogen plume. The initial polish is as received condition of cell phone glass. These types of glass are an alkali-aluminosilicate toughened sheet glass. Such types of cover glass combine thinness, lightness, with damage-resistance. It is used primarily as the cover glass for portable electronic devices, including mobile phones, portable media players, medical information display, portable computer displays, and some television screens. Generally, to obtain hydrophobic conditions for such types of glass, a variety of coatings are commonly employed. As apolar surfaces indicate low surface energy and increase contact angle as they mask functional groups of glass and cellulose. Silicon oxynitrides are expected to be created with this. Preliminary results for E-Ion Plasma exposure indicate that formation of nitrides appears to make such glasses hydrophobic.

The presented technique can alter the spacings and sizes of nano-pillars or grooves and other surface textures. The standard Wenzel and Cassie-Baxter surfaces with high stability can thus be made The energy and environment benefits range from low energy, less fluid use and re-entrant high abrasion resistant surfaces. Surface texture can be modified easily. Easy changes can be incorporated for flow control and improved energy in a generic cleaning sense. Note that by modifying texture the entire range of superhydrophillic, hydrophilic, hydropbhobic and super-hydrophobic can be made regardless of the surface energy. Similarly, oleophilic, super oleophilic, olephobic and superoleophobic can be made as can with any liquid or detergent. Such surfaces can easily modify or improve the cleanability with lower energy use. Such functions have use in boilers, heat exchangers, pipes, flat surfaces and complex surfaces. Data transfer oxide, non-oxide and combinations are considered as well as any combination of metal, ceramic, intermetallic, semi-conductor and soft materials like textiles and pliable or non-pliable rubbery compounds.

Any type of thermal plasma can be used including E-Ion Plasma which is a wide-area electro-shear-vibratory-thermal plasma that is expected to primarily enhance vibrational excitations in a flowing gas with the patented phonon-boson interactions that produce a stable plasma beam. This type of plasma, on account of a lack of electrodes, has the advantage of scalability and of allowing rapid processing of part-introduction and change-out, which is a must for volume production. The main benefit of E-Ion Plasma is wide-area stable plasma, including the open-plume stable configuration. This plasma has no combustion requirements (thus highly environment positive) and offers a clear reduced cost of processing in all configurations (inline or open discharge configurations).

### Spiked Oxy-Nitride Surfaces

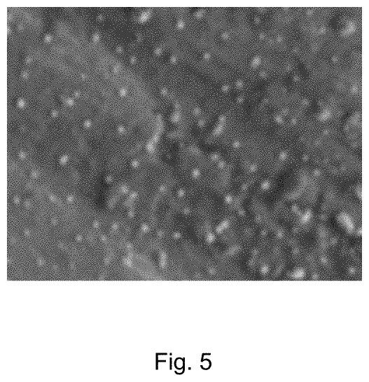

Equipment for space travel and exploration require a means for easy, low-energy dust removal. A preferred embodiment of the proposed method and system for the easy removal of surface dust is through the use of an in-situ grown nano-coating comprising of very hard nano-spike features (with spike spacings ˜50 nm and lower) that will (i) respond to very low energy methods (like gentle-tapping) for fine-dust removal, (ii) offer very high surface emissivity, (iii) will not delaminate even under abrasive conditions, (iv) be stable (no delamination) for wide temperature fluctuations and, (v) display permanent antimicrobial character that is common to all of the spiked features. It has also been discovered that such surfaces display good heat transfer characteristics. Plume-grown spiked oxynitride coatings on common metals and data-transfer-glass are contemplated. Very fine dust easily falls away from such surfaces when compared with the corresponding uncoated surface. A spiked oxynitride coating is quickly grown (within 15 seconds) on most metals and glass surfaces by a plasma-plume impingement on the surface as described above. FIG. 5 shows such nano-spikes.

Based on EBSD studies, the average coating thickness is in a range of ˜700 nm. Typical spikes are about 100 nm in height above the oxynitride surface. Such surfaces are hydrophobic which is otherwise may be accomplished with vacuum or chamber-based deposition techniques. The ionic or highly energized radical character of the beam places it at 10²¹ activated species per cubic meter. No vacuum is required. The processing is done at one atmosphere. The beam-power-density of the open plasma beam for the 10-15 KW units, assuming just equivalent of 0.1-1% ionization is 10⁶-10⁹ W/m² which is higher than most high-power lasers. The open plasma beams are about 200 mm long with diameters ranging from a few mm wide beam). There is no combustion, microwave or RF that is required—these prevent scalability. The plasma is produced at about 1 m³ flow of gas per 10-15 KW unit. The plasma exit velocity is about 1-10 m/s, or in other words, a volume of 0.02 to 0.2 m³ is produced per second for a 10 KW system. For gasses, one mole occupies 0.0224 m³. Thus, about ˜10²⁰-10²² ions or equivalent activated species are available per cubic meter.

Although dust repellant surfaces are expected to be hydrophobic it appears that hydrophobicity alone is not a sufficient surface condition for dust removal. Removal of dust by water droplets on hydrophobic and super-hydrophobic surfaces is well known. However, much less information exists about dry dust removal. It has been claimed, though, that it is easy to knock dust off from hydrophobic surfaces. Hydrophobicity can be enabled by very low surface energy materials but clearly this is not adequate for dust removal in many cases. Research by the applicants has shown that hydrophobicity that is imparted by spikes e.g., spiked oxynitride surface are required for easy dust dislodgement. To be effective in the shedding of dust, the spacing between the tips of the spikes needs to be less than the size of the dust particles to prevent the dust from falling between the spikes. Moon dust, which is very fine, adheres because of electrostatic, magnetic, and mechanical locking mechanisms. It appears that non-magnetic oxynitrides and hydroxy-nitrides spikes spaced at much smaller than the dust diameter are required for dust removal.

### Biphilic Nanostructures

Typically, when the heat flux is increased to a hot surface to enable the rapid boiling of water, a critical heat flux (CHF) limit is reached because of large nuclei and a stagnant vapor film formation. Biphilic nano-structuring is expected to provide a heater-material surface that can allow for an extremely high Heat Transfer Coefficient (HTC) at very high heat flux and avoid the vapor lock CHF. Considered further is the possible deformation of such surface textures with distortion-free twist surfaces. Recent literature and the applicant's own research have shown that the CHF limit can be avoided with a biphilic nanostructure, thus paving the way for a high steam production rate. The hydrophobicity promotes nucleation and departure whereas the hydrophilic state provides for a contact diameter to be smaller than the departure diameter thus preventing merging of adjacent bubbles to form a film (vapor lock). The key idea for enhanced heat transfer is to provide for the pinning of a hard-protective hydroxide layer with oxynitride pillaring, i.e. stable nanoparticles to create the instability (by manipulating the autocorrelation length and RMS of the pillars of the texture in adjacent regions) that will allow biphilic surfaces to display very high HTC. Although there is some lab scale experimental evidence of heat transfer enhancement with biphilic textures, presented here will be the first time deployment of surface texture enhanced steady-state steam production.

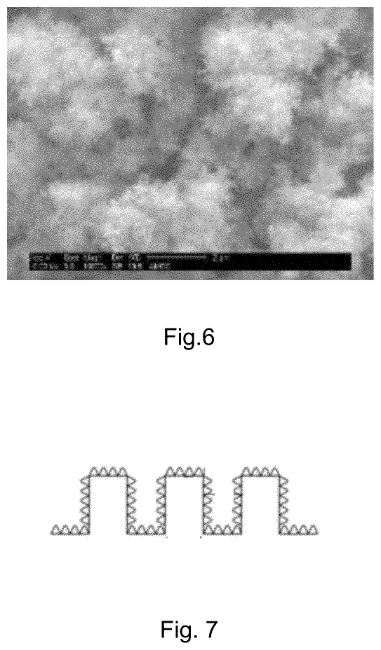

Review of Hydrophobic, Hydrophilic and Biphilic Textures. Films of continuous flowing water on surfaces break up into droplets on hydrophobic textured surfaces. Two types of wetting states are recognized for droplet interactions with nanostructure pillar-texture surfaces for roll-off, high velocity jump and disintegration. As stated above, these are the Wenzel (W) and Cassie-Baxter (CB) states. A composite region of hydrophobic and hydrophilic textures (i.e. a composite surface-texture) is referred to as a biphilic surface. The CB state gives rise to super-hydrophobicity. This droplet-surface interface is characterized by a large contact angle along with a small sliding angle. Hierarchical roughness, low surface energy material (like oxynitrides), and re-entrant/grooves are key for both super-hydrophobicity and super-oleo-phobicity. A CB state is an unstable state that aids the easy movement of droplets. In contrast, the fully wetted W state is usually more stable and stickier. Considerable attention has been paid to models and ideas for stabilizing the CB state by altering the roughness and pillar spacings (defined as the ratio of real to the projected area). Hierarchical roughness and re-entrant angle at the liquid-solid-air interface are key enablers to stabilize the CB composite state from transitioning to a W state-regardless of droplet size. However, such features also increase the resistance to further droplet collapse. For a lower roughness, e.g. with a larger pitch between the pillars (also called asperities), the W state is more energetically profitable, whereas for a higher roughness the CB regime is more energetically profitable. Consequently, rapid break up with an increased heat transfer coefficient is thought to be enabled by a biphilic state by promoting rapid nucleation and break up of any vapor film. Rapid droplet departure (boiling) is promoted by the hydrophobic surface or biphilic interface. Thus, with rapid departure conditions, local droplet-rolling is expected to create rapid nucleation and enable the high HTC and rapid water to steam conversion rate. There will be some dependency on the ratio of the droplet diameter (DL), to capillarity length (CL) a ratio of ˜1/30. With appropriate surface texturing, surfaces with interesting unidirectional spreading ability may possibly to enable a steady state boiling rate. FIG. 6 shows a hierarchical surface generated by the application of thermal plasma while FIG. 7 describes an idealized hierarchical surfaces comprised of layers or tiers of asperities.

Despite the great wetting properties and application potential, the technology for the implementation of uniquely textured surfaces is at a standstill for hard materials. This is mostly due to a lack of a reliable technique to provide for fully tunable and permanent nano-pillars (FIG. 3). The applicant has previously patented a novel method with an available electro-shear-plasma to overcome this limitation (U.S. Pat. No. 10,850,441) which is incorporated by reference in its entirety. The method employed in this patent may now be used to generate biphilic textured surfaces for steam production.

To design the best hydrophobic surface, the know design heuristics are important to follow. There is only limited guidance on stability, however some of it does exist. When the spacing is less than the width of a single pillar, Cassie's law is a poor predictor of the contact angle. The Cassie state could switch to the Wenzel state, resulting in a sudden breakdown of super-hydrophobicity. For higher roughness (i.e., where the pillar or spike spacing is less than the width of a pillar) the known Cassie equations do not describe the measured contact angle well in the higher (>0.25) roughness region. In this figure the range of solid area fraction covered is 0.12-0.79. The experimental data is compared with the prediction made numerically using Cassie's law. There is an asymmetry between the wetting and the de-wetting processes since less energy is released during wetting than de-wetting due to adhesion hysteresis. Rolling and vibration of the drop de-pins the contact line and relocates the droplet to an equilibrium position with a smaller equilibrium contact angle. At low roughness i.e., when pillars are widely spaced (solid area fraction is between 0 and 0.20), there is a good agreement between Cassie's law and the experimental data. Cassie droplets tend to have a low hysteresis compared with Wenzel droplets. In the CB condition, the droplet adherence is low, so the droplets can be shaken-off. The W condition is sticky. By creating biphilic texture we create conditions for rapid tiny-bubble nucleation from the superhydrophobic part and very tiny bubble departure (removal) that is critical to prevent vapor lock. In contrast, the hydrophilic state is common to metals as they have high surface energy. Regions of superhydrophobic texture may be created with the hydrophilic structure to yield a biphilic composite surface texture for easy droplet movement, nucleation, and discharge.

As mentioned above, surfaces with mixed wettability (biphilic) are expected to provide the best heat transfer characteristics due to the bubble dynamics, bubble size and departure detachment that impacts the boiling heat transfer limitations. There is limited guidance for an optimum hydrophobic area to total surface area ratio (A*=A_{hydrophobic}/Aₜₒₜₐₗ=˜38%) to achieve the best heat transfer performance. The two regions are expected to be separated by creating clusters of hydrophobic regions on the normally hydrophilic metal. Guidance from the literature suggests that the regions are best with a 20-40-micron separation with islands of hydrophobic regions-˜10 microns in diameter. There are two ways to cause this separation. The first is by masking and the second is by two stage deposition of flakes. The nano pillars of course are generally seen to be separated by ˜50 nm when the roughness (RMS) typically is ˜100 nm. The RMS/Autocorrelation length is used as the guiding parameter.

A technology requirement is for ultra-rapid evaporative heating without encountering cavitation or vapor lock on an electrically heated boiling surface. The steam must be continuous and not be in bursts. The target for the high continuous HTC is ˜5×10² KW/m²K. This application allows that the high steam rate (currently hampered by the available surfaces) can be incorporated in commercial steam production devices in a reliable fashion.

It is contemplated that the element material of choice will be selected from one of two new alloys, namely Fe-12% Cr˜18% Al-0.25% Ti (Ferritic) or the Fe—Ni—Cr alloy (Austenitic). These are the highest performing alloys in their class (that offer high heat flux emission). However, they are protected by different oxide morphologies. The ferritic alloy offers an adherent Al₂O₃ oxide layer whereas the austenitic alloy has a Cr₂O₃ protection (not as adherent). In one case the nano pillar structure will have to extend above the oxide and in the other case the oxide will delaminate after a certain thickness is obtained. These two alloys are commercially available in flat and round shapes. Like all metals, these two alloys have a high surface energy and are hydrophilic. Chalcogenide based substrates are contemplated as well.

Nano-pillar or spiked structures or surfaces of mainly iron-oxynitrides are grown on the material utilizing electro-shear-plasma. It has been found that electro-shear vibratory type of plasma is uniquely useful for surface texturing. When a nitrogen plasma interacts with a surface the nanoscale oxynitride pillars are seen to grow on the surface. These pillars can be manipulated by interaction time and beam intensity.

A carbon film may be introduced to provide the carbon atoms to the asperities when required. Carbon promotes sp3 XPS signals (i.e. makes the asperity harder). The typical interaction time is about 30 seconds for a 10 nm asperity to grow. The main benefits of such a plasma is the wide-area stable plasma conditions for open-plume stable configurations. No vacuum is required. The nano-pillar composition comprising of Fe (O, N, (C)), is easily noted from XPS (X-ray Photo-spectroscopy) and the EDX (Energy Dispersive X-ray) measurements (except for the nitrogen signal which verified with XPS). The surface energy falls to 25 mJ/m2 for oxynitrides (hydrophobic) because of the oxynitrides. Note that the base metal is ˜800 mJ/m2 (hydrophilic). The nano-pillar structure makes it hydrophobic and provides the condition for droplet ejection. The composition is tunable which gives rise to variations in band gap and strength.

To determine the heat transfer coefficient as a function of the heat flux, one has to calculate the heat flux based on the power input i.e. V.I (voltage across the plate×electric current to maintain the 10 W/cm²) and assume an “h” that will permit matching the eight thermocouples and the boiling rate (experimental). Electric heat dissipation (V.I) minus the heat conduction loss in the clamps will be the input. On the solid surface, the heat balance condition will be applied, i.e., energy received by the surface from conduction in the solid equals energy loss by radiation plus steam boiling and gas superheating (from experimental measurement). Matching the measured surface temperature, the temperature along exit condenser tube with the boiling rate will allow determination of the heat transfer coefficient from the Newton's law of cooling. In several studies it has been concluded that the interface heat-coefficient is extremely sensitive to fluid flow (dh/dp of 0.01 to 1 ms⁻¹ K⁻¹).

Although preferred embodiments of the structure and method are presented in the above specification, the scope of the invention is not to be limited by them. Other substrate and layer materials are contemplated as well. The hierarchical surface may be applied to any other appropriate metallic and non-metallic surface. It is contemplated by the applicants that the terms roughness, perturbations, grooves, pillars and asperities are to be used interchangeably. Also, the compositions of the substrate and roughness can be similar or graded. Asperity shapes may be of types that provide characteristics other than hydrophobicity or anti-microbial behaviors.

We claim:

1. A self-cleaning structure comprising: a substrate and a hierarchical surface comprised of a first layer of asperities thereby providing the surface with dust repelling characteristics.

2. The self-cleaning structure of claim 1 wherein the asperities of the first layer are nano-scale.

3. The self-cleaning structure of claim 1 wherein the substrate is comprised of a metal from the list comprising aluminum, steel, bronze, titanium, zirconium, and binary and multicomponent alloys.

4. The self-cleaning structure of claim 1 wherein the substrate is comprised from the list of materials including silicon, oxygen, hydrogen, carbon, phosphorous and nitrogen compound and alloys.

5. The self-cleaning structure of claim 1 wherein the substrate is comprised of glass from the list comprising oxide based or chalcogenide based or combinations.

6. The self-cleaning structure of claim 1 wherein the asperities of the first layer are grooves.

7. The self-cleaning structure of claim 1 wherein the asperities of the first layer are spiked shaped.

8. The self-cleaning structure of claim 1 wherein the asperities of the first layer are spaced at a distance less than the diameter of the particles expected to contact the surface.

9. The self-cleaning structure of claim 1 wherein the asperities are comprised of oxynitrides.

10. The self-cleaning structure of claim 1 wherein the surface is generated by the application of thermal plasma.

11. The self-cleaning surface structure of claim 1 wherein a second layer of asperities is applied over the asperities of the first layer.

12. The self-cleaning surface structure of claim 11 wherein the asperities of the first layer are in the micro-scale and the asperities of the second layer are in the nano-scale.

13. The self-cleaning surface structure of claim 11 wherein there are further layers of asperities applied over the asperities of the second layer.

14. A hydrophobic nano-surface comprising: asperities in the form of grooves and asperities in the form of pillars, wherein the asperities in the form of pillars are positioned directly on top of the asperities in the form of grooves.

15. The hydrophobic nano-surface of claim 14 wherein the asperities are comprised of oxynitrides.

16. The hydrophobic nano-surface of claim 14 wherein the surface is generated by the application of thermal plasma.

17. A biphilic surface comprised of both hydrophobic and hydrophilic regions wherein the hydrophobic and hydrophilic regions are comprised of nano-scale asperities.

18. The biphilic surface of claim 17 wherein the asperities are comprised of oxynitrides.

19. The biphilic surface of claim 17 wherein the asperities are spiked shaped.

20. The biphilic surface of claim 17 wherein the surface is generated by the application of thermal plasma.
